(19) United States
(12) Patent Application Publication
(10) Pub. No.: US 2026/0064229 A1
(43) Pub. Date: Mar. 5, 2026

(54) OPTICAL FLOW SENSORS ADAPTIVE TO DIFFERENT COVER STACK THICKNESSES

(71) Applicant: Apple Inc., Cupertino, CA (US)

(72) Inventors: Yongkang Gao, Sunnyvale, CA (US); Tong Chen, Fremont, CA (US); David D. Dashevsky, San Jose, CA (US)

(21) Appl. No.: 19/303,334

(22) Filed: Aug. 18, 2025

Related U.S. Application Data
(60) Provisional application No. 63/690,350, filed on Sep. 4, 2024.

(51) Int. Cl. G06F 3/042; G06F 3/03

(52) U.S. Cl. CPC G06F 3/0421; G06F 3/0317

(57) ABSTRACT

An opto-electronic device includes an optical sensor. The optical sensor includes an image sensor having a two-dimensional (2D) array of pixels, and a light source operable to illuminate at least a portion of a field of view imaged by the image sensor. The opto-electronic device also includes a cover stack that passes light emitted by the light source and light received by the image sensor, and a processor. The processor is configured to determine a thickness of the cover stack, and operate at least a portion of the 2D array of pixels in one of a binned pixel mode or a non-binned pixel mode, responsive to the determined thickness of the cover stack.

### CROSS REFERENCE TO RELATED APPLICATION

This application is a nonprovisional and claims the benefit under 35 U.S.C. § 119(e) of U.S. Provisional Ser. No. 63/690,350 , filed Sep. 4, 2024, entitled “OPTICAL FLOW SENSORS ADAPTIVE TO DIFFERENT COVER STACK THICKNESSES,” the contents of which are incorporated herein by reference as if fully disclosed herein.

### FIELD

The described embodiments generally relate to optical flow sensors.

### BACKGROUND

Optical flow sensors are widely used to detect near field user input and user interaction in consumer electronic devices. For example, an optical flow sensor may be used as an optical mouse navigation sensor or an optical finger navigation sensor.

### SUMMARY

Embodiments of the systems, devices, methods, and apparatus described in the present disclosure are directed to optical flow sensors that are adaptive to different cover stack thicknesses. An optical flow sensor is an optical sensor that tracks movement of a target by comparing two or more images of a surface texture of the target.

Traditionally, an optical flow sensor is designed to function beneath a module or device cover through which the optical flow sensor transmits and receives light. For example, transmitted light may pass through the cover and be redirected from (e.g., reflected or scattered from) a target. The redirected light may then pass back through the cover and be sensed by the optical flow sensor. However, in some cases, a user may modify a cover stack that includes the cover through which the optical flow sensor transmits and receives light. For example, a user may apply a screen protector to a mobile phone's or tablet computer's cover glass, and/or the user may place their device within a case that has a light-transmissive panel. These modifications to the cover stack through which an optical flow sensor transmits and receives light may induce flare on an image sensor of the optical flow sensor; change an optical contrast of target features imaged by the image sensor; and/or change a magnification ratio of features images by the image sensor. These changes may interfere with the optical flow sensor's ability to track movement of a target and/or accurately estimate a distance or speed of movement of the target. Described herein are optical flow sensors (and optical sensors, more generally) that are able to sense through, or adapt their sensing to, a range of cover stack thicknesses.

In a first aspect, the present disclosure describes an opto-electronic device. The opto-electronic device may include an optical sensor. The optical sensor may include an image sensor having a two-dimensional (2D) array of pixels, and a light source operable to illuminate at least a portion of a field of view imaged by the image sensor. The opto-electronic device may also include a cover stack that passes light emitted by the light source and light received by the image sensor, and a processor. The processor may be configured to determine a thickness of the cover stack, and operate at least a portion of the 2D array of pixels in one of a binned pixel mode or a non-binned pixel mode, responsive to the determined thickness of the cover stack.

In a second aspect, the present disclosure describes another opto-electronic device. The opto-electronic device may include a cover stack and an optical sensor. The optical sensor may be positioned on a first side of the cover stack and configured to sense movement of a target on a second side of the cover stack. The second side is opposite the first side. The optical sensor may include an image sensor having a 2D array of pixels, a light source operable to illuminate at least a portion of a field of view imaged by the image sensor, and a depth of field (DoF) extension lens disposed between the image sensor and the cover stack, in a light reception path of the image sensor.

In a third aspect, the present disclosure describes another opto-electronic device. The opto-electronic device may include a cover stack, an optical sensor, and a processor. The optical sensor may be positioned on a first side of the cover stack and configured to sense movement of a target on a second side of the cover stack. The second side is opposite the first side. The optical sensor may include an image sensor having a 2D array of pixels. The processor may be configured to acquire an image from the 2D array of pixels; analyze the image to determine at least one of whether flare is in the image, a presence or position of flare in the image, or a position of a target or target feature in the image, and adapt the image sensor based at least in part on the analysis.

In addition to the aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A and 1B show examples of an opto-electronic device that includes an optical flow sensor;

FIG. 2A shows an image without flare acquired by the image sensor under the cover stack thickness shown in FIG. 1A;

FIG. 2B shows an image with flare acquired by the image sensor under the cover stack thickness shown in FIG. 1B;

FIG. 2C shows another image acquired by the image sensor under the cover stack thickness shown in FIG. 1A;

FIG. 2D shows an image acquired by the image sensor under the cover stack thickness shown in FIG. 1B, which image has experienced contrast loss in comparison to the image shown in FIG. 2C;

FIGS. 2E and 2F show respective images before and after sensor pixelization, as may be acquired by the image sensor under the cover stack thickness shown in FIG. 1A;

FIGS. 2G and 2H show respective images before and after sensor pixelization, as may be acquired by the image sensor under the cover stack thickness shown in FIG. 1B, and with the image shown in FIG. 2H having lost tracking features;

FIGS. 3A and 3B show examples of an opto-electronic device having a modified optical flow sensor compared to the optical flow sensor shown in FIGS. 1A and 1B;

FIGS. 4A and 4B show examples of an adaptable image sensor, which image sensor may be used in some cases as the image sensor described with reference to FIGS. 3A and 3B;

FIG. 5 shows an example method that may be performed by a processor of an optical flow sensor;

FIGS. 6A and 6B show an example of a device that may include an optical flow sensor; and

FIG. 7 shows a sample electrical block diagram of an electronic device that includes an optical flow sensor.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments and appended claims.

Traditional optical flow sensors typically consist of an infrared (IR) light emitting diode (IR-LED) light source, some beam shaping optics, and LED driving circuitry on the transmitter side, and imaging optics, an image sensor, and on-chip digital signal processing (DSP) circuitry on the receiver side. The LED driving circuitry, image sensor, and on-chip DSP circuitry are usually integrated on the same silicon die, together with necessary power and input/output (I/O) interface and management circuitry. An optical flow sensor module assembly usually also includes a case, a substrate, a flexible (flex) circuit, et cetera.

An optical flow sensor may in some cases be installed behind an IR-transmissive cover, such as a glass, crystal, or plastic cover. A target to be sensed by the optical flow sensor, such as a user finger moving on top of the cover, can be illuminated by the light source of the optical flow sensor. Frame-to-frame movement of an illuminated target (e.g., movement of a fingerprint, other target texture, or other characteristic of the target (including, in some cases, the target as a whole)) may be captured by the image sensor of the optical flow sensor and processed by on-chip DSP circuitry implementing an optical flow algorithm to reconstruct the frame-to-frame movement of the target.

An optical flow sensor may be configured to account for minor uncertainties due to hardware manufacturing tolerances, sensor assembly variations, sensor usage conditions, et cetera. However, due to its compact size and cost considerations, an optical flow sensor is usually designed for optimal performance under specific system usage conditions, including a specific cover type and thickness, a specific module-to-interior cover surface air gap, a specific target-to-exterior cover surface air gap (if any), et cetera.

When an optical flow sensor is integrated into a consumer electronic device, the device user may sometimes supplement or modify the IR-transmissive cover over the optical flow sensor. For example, the user may choose to place one or more IR-transmissive protection layers on or over the cover. Such protection layers may include, for example, a screen protector, a phone case, or a tablet computer sleeve. Sometimes, a user may place more than one protection layer on or over the cover, such as a screen protector and a phone case. Such user modification of system conditions is a major challenge and failure mode for optical flow tracking.

In some cases, an IR-transmissive protection layer may produce flare on the optical flow sensor's image sensor (e.g., as a result of a new, additional, or altered specular reflection path caused by the additional thickness of the “cover stack” and/or a new or additional interface between dissimilar materials of the cover stack). Flare can obfuscate features of a target that are useful or needed for target movement tracking.

For purposes of this description, a “cover stack” is defined to be a set of one or more layers through which an optical flow sensor needs to transmit and receive light to sense movement of a target on a side of the cover stack opposite the optical flow sensor. In some cases, an optical cover stack may include, for example, one or more of a screen protector; an IR-transmissive case; a layer of adhesive between a cover and a screen protector; an air gap between a cover and an IR-transmissive case; an air gap between a screen protector and an IR-transmissive case; a privacy screen; smudges on or between one or more protective layers; et cetera.

In some cases, an IR-transmissive protection layer may additionally or alternatively change the focus of an image on an optical flow sensor's image sensor (i.e., reduce the contrast or blur target features). This can make it more difficult to track movement of a target, or may reduce the resolution or certainty at which target movement can be tracked, or in more extreme cases can lead to loss of target tracking. In some cases, an IR-transmissive protection layer may additionally or alternatively change the magnification ratio of a target or target features detected by the image sensor. This can result in image under-sampling and misinterpretation of target movement (e.g., because of a change in ratio between a target feature moving x distance units on an exterior surface of the cover stack and moving y′ (versus y) distance units on the surface of an image sensor).

In some cases, an IR-transmissive protection layer may change or introduce two or more of the above variables.

Described herein are new optical flow sensors that are adaptive to different cover stack thicknesses. The described sensor architectures and methods of sensing ensure consistent optical flow tracking performance and user experience (within limits) regardless of user modification of a cover stack over an optical flow sensor. Some of the described architectures are applicable to other types of optical sensors, such as laser speckle flow sensors (optical sensors that track movement of a target by comparing two or more laser speckle images/patterns).

The described optical flow sensors include one or more of: a transceiver optical design that provides a desired target illumination but mitigates or avoids flare from a cover stack, so long as the cover stack has a cover stack thickness within a cover stack thickness range of interest (ROI); a transceiver optical design that provides an optimal depth of field (DoF) and magnification ratio for a cover stack thickness within the cover stack thickness ROI; a transceiver optical design that provides cover stack thickness-dependent flare (e.g., cover surface flare) on an image sensor, such that a cover stack thickness may be determined from an analysis of the flare on the image sensor; a transceiver optical design that provides cover stack thickness-dependent target illumination, such that a cover stack thickness may be determined from a position of a target image or target feature image on an image sensor; or a transceiver image sensor design that provides a cover stack thickness-adaptive image sensor read-out (e.g., a read-out of only pixels within a region of interest (ROI), or a read-out of binned or non-binned pixels); and/or a sensor method that enables adaptation of an image sensor read-out ROI, pixel binning mode, optical flow velocity/displacement gain factor, et cetera based at least in part on a determined cover stack thickness.

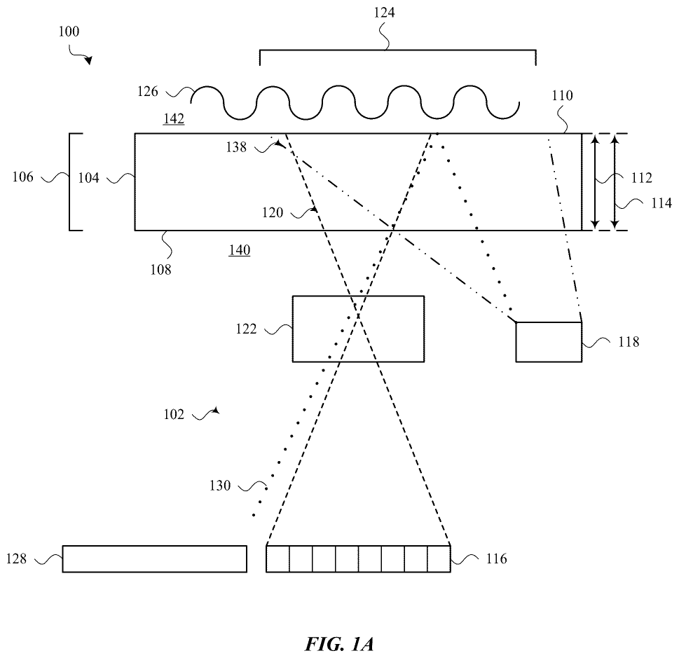

FIGS. 1A and 1B show examples of an opto-electronic device 100 that includes an optical flow sensor 102 (or more generally, an optical sensor). As shown in FIG. 1A, the optical flow sensor 102 may be positioned below (or on a first side 140 of) a cover 104 that defines a cover stack 106. By way of example, the cover 104 may be formed of glass, crystal, or plastic. In some embodiments, the cover stack 106 may include more than one layer, of which one layer is the cover 104. The cover 104 may have an interior surface 108 and an exterior surface 110, separated by a cover thickness 112. In the case of the embodiment shown in FIG. 1A, a cover stack thickness 114 is equal to the cover thickness 112.

The optical flow sensor 102 may be used to sense, or detect movement of, a target (e.g., a finger) on a second side 142 of the cover stack 106. The optical flow sensor 102 may include an image sensor 116 and a light source 118. The image sensor 116 may have a two-dimensional (2D) array of pixels, and in some cases may be a complimentary metal-oxide semiconductor (CMOS) image sensor. The 2D array of pixels may be oriented parallel to the cover 104 (though it need not be). The image sensor 116 may image a field of view 120, with images produced by the image sensor 116 generally being images of an targets or target features within the field of view 120. In some embodiments, receive (Rx) optics 122 (e.g., one or more lenses, gratings, coatings, filters, or optical steering mechanisms) disposed between the image sensor 116 and the cover stack 106, in a light reception path of the image sensor 116, may at least partly define the field of view 120.

The light source 118 may be operable to illuminate at least a portion of the field of view 120. In some embodiments, the light source 118 may include one or more light emitting diodes (LEDs). The light source 118 may alternatively include one or more laser light sources (e.g., one or more vertical cavity surface-emitting lasers (VCSELs) or other light source(s) that are capable of directly, or with optics, providing more than spot illumination (or in the case of other types of optical sensor, spot illumination)). In some embodiments, the light source 118 may be an IR light source, in which case the cover 104 and Rx optics 122 may be IR-transmissive, and the image sensor 116 may be configured or filtered to be IR-only sensitive. In other embodiments, the optical flow sensor 102 may be configured to emit and sense near IR (NIR) light, ultraviolet (UV) light, or another wavelength (or range of wavelengths) of light in a visible or non-visible range. An example illuminated region 124 on the exterior surface 110 of the cover 104 is shown in FIG. 1A.

During optical flow sensor operation, the cover stack 106 may pass light 138 emitted by the light source 118 and light received by the image sensor 116 (e.g., a portion of the light emitted by the light source 118 that is redirected by a target). As shown, the target may in some cases be a user's finger 126. The finger 126 may define a fingerprint having one or more ridges and valleys. The finger 126 (or other target) may be illuminated by the light source 118 as it touches or is moved on or near the cover 104. A portion of the finger 126 that is within the field of view 120 of the image sensor 116 may be imaged by the image sensor 116. As the finger 126 is moved, different portions of the finger 126 may be imaged by the image sensor 116. When the frame rate of the image sensor 116 is sufficiently fast (e.g., substantially faster than the speed at which the finger 126 is moved on the exterior surface 110), characteristics of the user's finger movement may be determined (e.g., whether the finger 126 is moving, a direction of movement along the exterior surface 110, a speed of movement along the exterior surface 110, and in some cases, aspects of movement toward or away from the exterior surface 110). The characteristics of target movement (e.g., finger movement) may be determined by a processor 128 (e.g., DSP circuitry) that is in communication with the image sensor 116 and/or a memory that temporarily stores image data read from the image sensor 116. In some embodiments, two or more of the image sensor 116, the light source 118, and the processor 128 may be mounted on the same integrated circuit (IC) chip and/or included in the same module.

Some of the light that is emitted by the light source 118 may specularly reflect from the interior surface 108 or exterior surface 110 of the cover 104, or from coatings on the cover 104, or from interfaces between various layers in the cover stack 106. A singular specular reflection path 130 is shown in FIG. 1A, but other specular reflection paths may exist. In some embodiments, the image sensor 116, light source 118, Rx optics 122, and their positions and orientations may be designed such that the specular reflection path 130 (and in some cases other specular reflection paths) do not impinge on the image sensor 116, thus avoiding flare (bright light that does not contain information pertaining to an image of a target (e.g., the user's finger 126) and saturates one or more pixels of the image sensor 116).

FIG. 1B also shows the optical flow sensor 102 positioned below the cover 104 (i.e., on the first side 140 of the cover stack 106). However, in the embodiment of FIG. 1B, a user has applied a screen protector 132 to the cover 104 (or placed their device in a case having a light-transmissive cover 132). In this case, the cover stack thickness 114 is greater, and in some cases much greater (e.g., 2×-3×), than the cover thickness 112. As a result, the optical flow sensor 102 may be subjected to various conditions for which it was not designed, and the performance of the optical flow sensor 102 may deteriorate as attempts to track the presence and/or movement of a target (e.g., a finger 126) on or near an exterior surface 134 of the screen protector 132 (i.e., on the second side 142 of the cover stack 106).

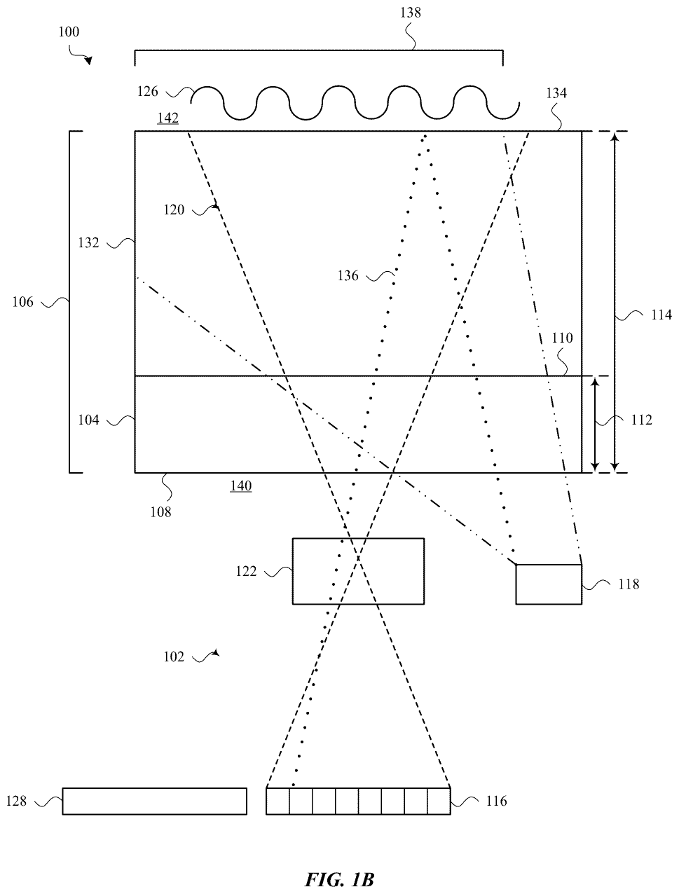

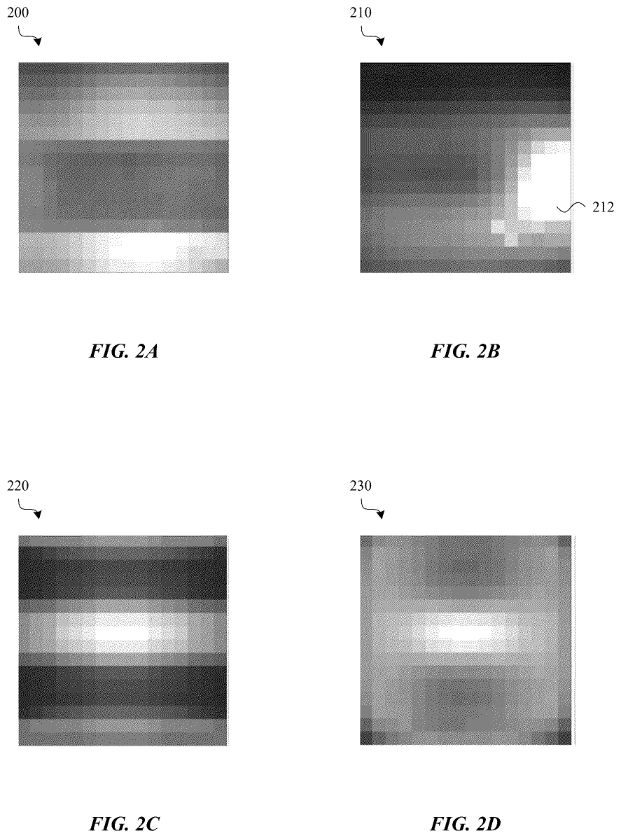

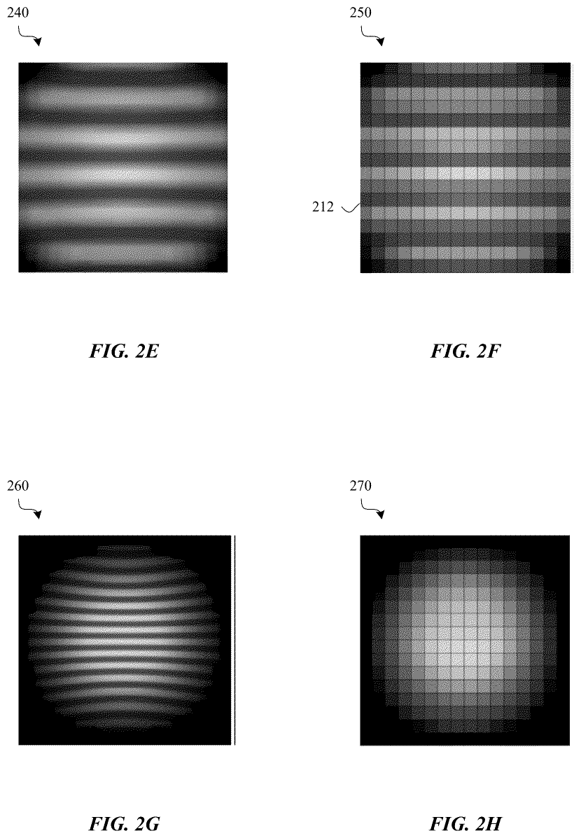

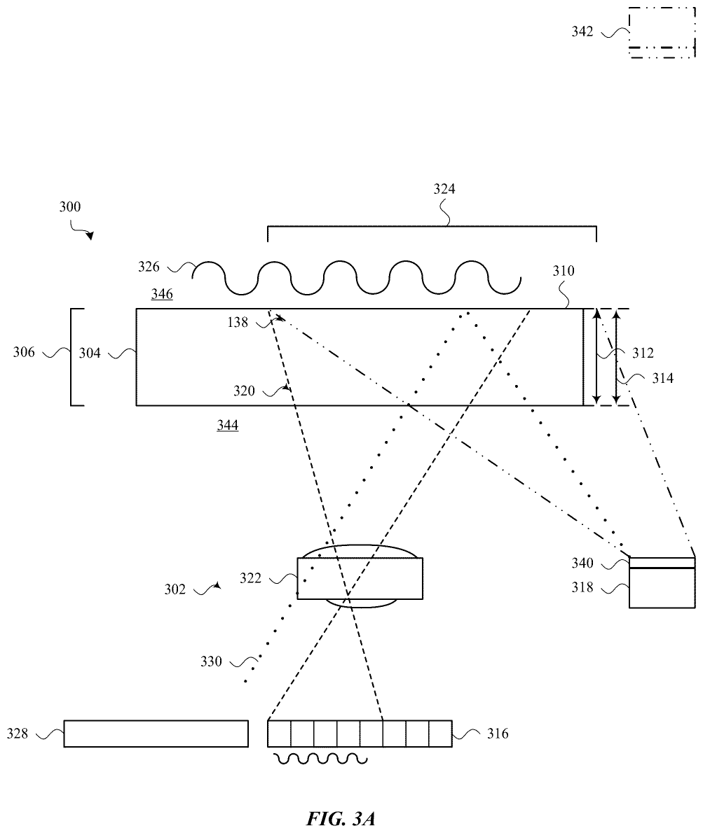

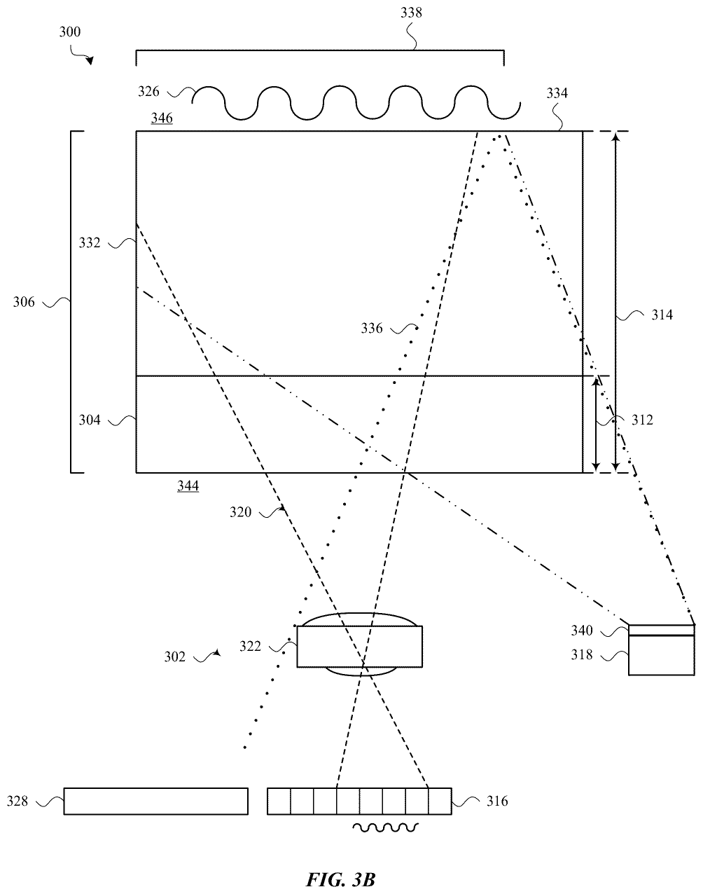

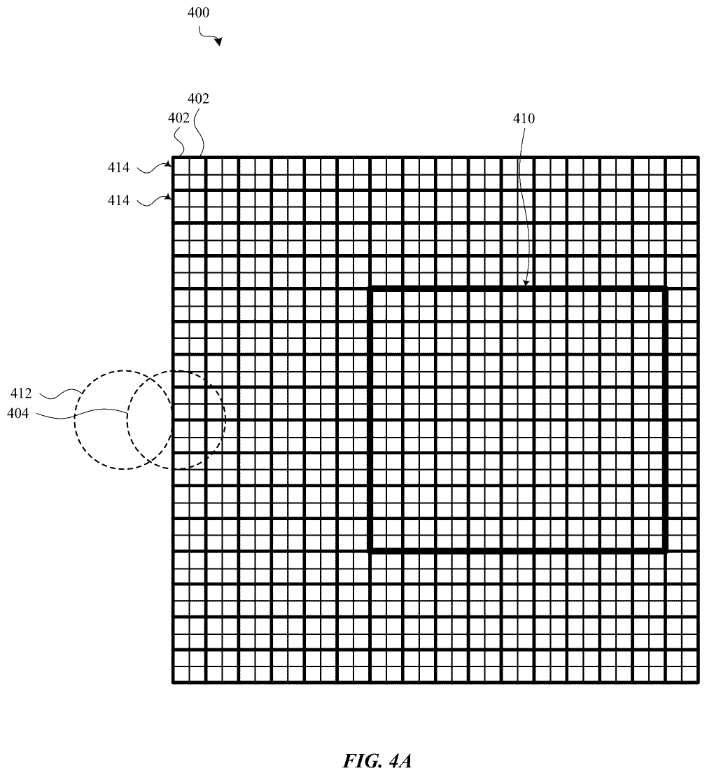

For example, there may be additional or different specular reflection paths between the light source 118 and the image sensor 116. A specular reflection path 136 that does not exist in the device configuration shown in FIG. 1A now impinges on the image sensor and may produce flare. The flare may obscure useful tracking features that the image sensor 116 might otherwise be able to detect. FIG. 2A shows an image 200 without flare acquired by the image sensor 116 under the cover stack thickness 114 shown in FIG. 1A, and FIG. 2B shows an image 210 with flare 212 acquired by the image sensor 116 under the cover stack thickness 114 shown in FIG. 1B.

As another example of deterioration in optical flow sensor performance, the increased cover stack thickness in FIG. 1B may result in contrast loss (or blur) in images acquired by the image sensor 116. Contrast loss results because of the imaging defocus that results from the increased thickness of the cover stack 106. Contrast loss can make it difficult to track a target—especially when the target is moving fast, but also when the target is moving more slowly. Features of a target may blur into other features and may be difficult or impossible to distinguish—even after the application of image post-processing techniques. FIG. 2D shows an image 230 acquired by the image sensor 116 under the cover stack thickness 114 shown in FIG. 1B, which image 230 has experienced contrast loss in comparison to the image 220 shown in FIG. 2C acquired by the image sensor 116 under the cover stack thickness 114 shown in FIG. 1A.

As another example of deterioration in optical flow sensor performance, the increased cover stack thickness in FIG. 1B may change the magnification ratio of images acquired by the image sensor 116. A change in magnification ratio can lead to tracking uncertainties. For example, a change in magnification ratio can cause a downstream algorithm to determine incorrect distance or movement speeds. A change in magnification ratio can also lead to fewer features being available for tracking and also, in some cases, feature loss after image pixelization. FIG. 2G shows an image 260 acquired by the image sensor 116 under the cover stack thickness 114 shown in FIG. 1B, and FIG. 2H shows an image 270 after image sensor pixelization of image 260, which image 270 has lost tracking features. In comparison, image 240 in FIG. 2E and image 250 in FIG. 2F show images before and after sensor pixelization, as may be acquired by the image sensor 116 under the cover stack thickness 114 shown in FIG. 1A.

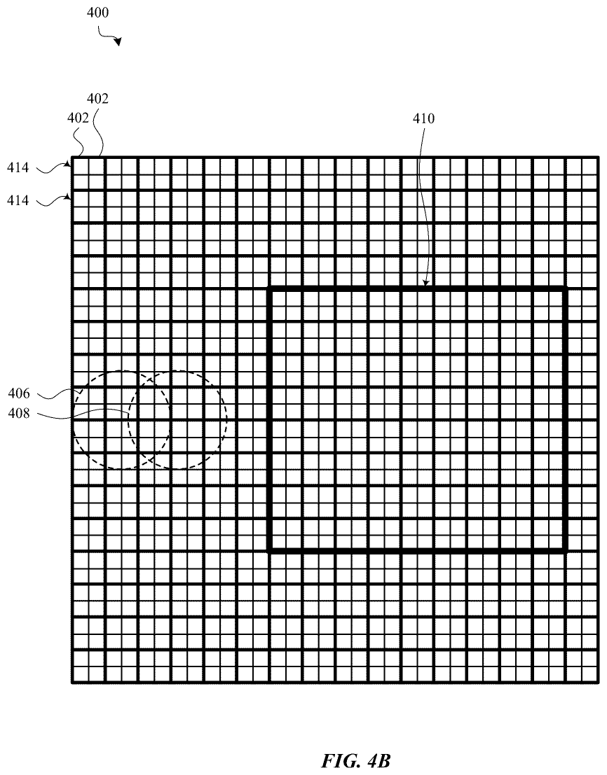

FIGS. 3A and 3B show examples of an opto-electronic device 300 having a modified optical flow sensor 302 (or more generally, an optical sensor). Similarly to what is shown and described with reference to FIGS. 1A and 1B, the optical flow sensor 302 may be positioned below a cover stack 306 that includes a cover 304 (i.e., on a first side 144 of the cover stack 306). The cover stack 306 may optionally include one or more layers that are stacked on or positioned over the cover 304 (e.g., the screen protector 332 shown in FIG. 3B). The cover stack 306 may have a cover stack thickness 314. The cover stack thickness 314 is greater in the example shown in FIG. 3B (in comparison to the example shown in FIG. 3A).

The optical flow sensor 302 may include an image sensor 316 and a light source 318, with the image sensor 316 having a 2D array of pixels. The image sensor 316 may image a field of view 320. In some embodiments, Rx optics 322 (e.g., one or more lenses, gratings, coatings, filters, or optical steering mechanisms) may at least partly define the field of view 320.

The light source 318 may be operable to illuminate at least a portion of the field of view 320. An example illuminated region 324 on an exterior surface 310 of the cover 304 is shown in FIG. 3A. An example illuminated region 338 on an exterior surface 334 of the screen protector 332 is shown in FIG. 3B.

As shown, a target, such as a user's finger 326 having a fingerprint including one or more ridges and valleys, may be illuminated by the light source 318 as it touches or is moved on or near the exterior surface 310 of the cover 304 (FIG. 3A) or on or near the exterior surface 334 of the screen protector 332 (FIG. 3B) (i.e., on a second side 346 of the cover stack 406). A portion of the finger 326 that is within the field of view 320 of the image sensor 316 may be imaged by the image sensor 316.

A processor 328 (e.g., DSP circuitry) may be in communication with the image sensor 316 and/or a memory that stores image date obtained from the image sensor 316.

The optical flow sensor 302 may differ from the optical flow sensor described with reference to FIGS. 1A and 1B in one or more respects. For example, the light source 318 may be associated with transmit (Tx) optics 340 that shape or direct the light emitted by the light source 318. For example, the Tx optics 340 may include a beam-shaping lens disposed between the light source 318 and the cover stack 306, in a light emission path of the light source 318. Although the Tx optics 340 (and beam-shaping lens) are shown to be on the light source 318, the Tx optics 340 need not be on the light source 318, or may have some components that are on the light source 318 and some components that are not on the light source 318. The beam-shaping optics 340 may direct the light emitted by the light source 318 into the field of view 320 of the image sensor 316, and an axis of the emitted light may be non-perpendicular to the surfaces of the cover stack 306 and the surface of the image sensor 316. Additionally or alternatively, the light source 318 may be mounted such that the axis of the light emitted by the light source is non-perpendicular to the surfaces of the cover stack 306 and the surface of the image sensor 316.

FIG. 3A shows a mirror image 342 of the light source 318 with respect to the exterior surface 334 of the cover stack 306. A similar mirror image could be drawn for the light source 318 with respect to the exterior surface 334 of the cover stack 306 shown in FIG. 3B. The mirror image 342 in each of FIGS. 3A and 3B determines, in part, the trajectory of a specular reflection 330, 336 from the exterior surface 324, 334 of the cover stack 306. For example, when a mirror image (e.g., mirror image 342) intersects the field of view 320 and marginal rays from the mirror image impinge on the aperture of Rx optics (e.g., Rx optics 322), a specular reflection is likely to occur. As a result, the locations of the mirror images (e.g., 342) and marginal rays can be used, at least in part, to determine where to position the light source 318, how to orient the light source 318, and/or what Tx optics 340 to use in conjunction with the light source 318, to either 1) ensure that specular reflections from different thicknesses of cover stack 306 do not impinge on the image sensor 316, or 2) control how specular reflections from different thicknesses of cover stack 306 impinge or do not impinge on the image sensor 316. In the former case, specular reflections for a range of cover stack thicknesses can be avoided, and for the latter, specular reflections can be used to determine the thickness 314 of the cover stack 306. In general, moving the position of the light source 318 farther away from the image sensor 316 tends to increase the range of cover stack thicknesses 314 for which specular reflections 330, 336 on the image sensor 316 can be avoided.

In some embodiments, the mirror image of the light source 318 may be outside the field of view 320 imaged by the image sensor 316 for at least a range of thicknesses 314 of the cover stack 306 up to two times the thickness 312 of the cover 304. In other embodiments, the mirror image of the light source 318 may be outside the field of view 320 imaged by the image sensor 316 for at least a range of thicknesses 314 of the cover stack 306 up to three times the thickness 312 of the cover 304. The light source 318 and/or other system components may also be positioned, oriented, and/or designed such that the mirror image of the light source 318 is outside the field of view 320 for other ranges of cover stack thicknesses 314.

As an additional or alternative difference between the optical flow sensor 302 and the optical flow sensor described with reference to FIGS. 1A and 1B, the Rx optics 322 may include a DoF extension lens that maintains a constant target magnification ratio on the image sensor 316 for a range of cover stack thicknesses 314 and target locations. Alternatively, the Rx optics 322 may be configured to direct (or better direct) light received at different angles of incidence on the Rx optics 322 (e.g., light emitted by the light source 318 and reflected from the target (e.g., the user's finger 326)) to different portions of the image sensor 316. For example, and as shown, the Rx optics 322 may be configured to direct light reflected at a first range of angles, from a finger on the exterior surface 324 of the cover 304, to a first region on the image sensor 316, and to direct light reflected at a second range of angles, from the finger 326 on the exterior surface 334 of the screen protector 332, to a second region on the image sensor 316.

As another additional or alternative difference between the optical flow sensor 302 and the optical flow sensor described with reference to FIGS. 1A and 1B, the image sensor 316 may be adaptive. For example, the image sensor 316 may be adapted so that the values of pixels in different regions of interest (ROIs) and/or different resolutions of pixel values may be read out from the image sensor 316, depending on a particular cover stack thickness 314 (e.g., the cover stack thickness 314 shown in FIG. 3A or 3B). Image sensor adaptations may be made, in some embodiments, to avoid reading out values of pixels affected by flare. Image sensor adaptations may also or alternatively be made to account for target images appearing in different ROIs, depending on the cover stack thickness 314, and/or for differences in magnification ratio caused by different cover stack thicknesses.

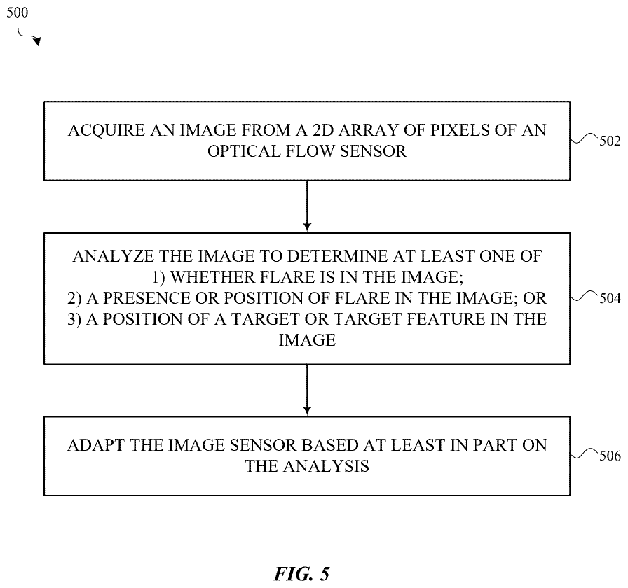

FIGS. 4A and 4B show examples of an adaptable image sensor 400, which image sensor 400 may be used in some cases as the image sensor described with reference to FIGS. 3A and 3B. The image sensor 400 may also be used in other types of optical sensors, such as laser speckle flow sensors. The image sensor 400 may include a 2D array of pixels 402. By way of example, a 32×32 array of pixels 402 is shown. In other embodiments, the 2D array of pixels may include more or fewer pixels, and in some cases may include a rectangular array of pixels (e.g., an M×N array where each of M and N are integers greater than or equal to one).

Under a particular set or range of operating conditions, none (or only a small portion) of the pixels 402 may experience flare. For example, in the scenario shown in FIG. 3A, in which an optical flow sensor is disposed under a cover stack without modification (e.g., a cover without a screen protector or case), the image sensor 400 may be positioned within an optical flow sensor and/or device, or components of the optical flow sensor and/or device may be positioned or designed, such that a specular reflection 412 of light emitted by a light source of the optical flow sensor misses the image sensor 400, as shown in FIG. 4A. In contrast, in the scenario shown in FIG. 3B, in which the optical flow sensor is disposed under a cover stack that has been modified to include a screen protector or case, a specular reflection of light emitted by the light source of the optical flow sensor may impinge on the image sensor 400, as shown in FIG. 4A, and a subset of pixels 402 of the image sensor 400 may experience flare 404.

FIG. 4B shows an alternative positioning of the image sensor 400 within an optical flow sensor and/or device, or an alternative positioning or design of components of the optical flow sensor and/or device. In this example, a first subset of pixels 402 of the image sensor may experience flare 406 when a cover stack only includes a cover, as shown in FIG. 3A, and a second subset of pixels 402 of the image sensor may experience flare 408 when the cover stack is modified to include a screen protector or case, as shown in FIG. 3B.

In each of the examples shown in FIGS. 4A and 4B, it can be appreciated that a subset of pixels 402 of the image sensor 400 may or may not experience flare, or different subsets of pixels may experience flare, depending on the thickness of a cover stack through which an optical flow sensor including the image sensor 400 emits and receives light. These changes in the incidence of flare on the image sensor 400, and the analysis of same by a processor, may be used to determine the thickness of a cover stack. For example, a processor may be configured to acquire at least one image from the image sensor 400, analyze a pattern of light in the at least one image, and determine the thickness of a cover stack based at least in part on the analysis of the pattern of light. In some embodiments, the processor's analysis of the pattern of light may include determining the presence or position of flare in acquired image or images (e.g., determining which pixels 402, if any, are experiencing flare). Additionally or alternatively, and in some embodiments, the processor's analysis of the pattern of light may include determining one or more of a position of a target or target feature within an image acquired from the image sensor 400; the size, resolution, or sharpness (or blur) of features in an imaged target; et cetera. Alternatively, a processor may determine the thickness of a cover stack based at least in part on a received thickness (e.g., a cover stack thickness input by a user), or based at least in part on an identifier of a layer of a cover stack (e.g., a user input indicating whether a screen protector or case is disposed over a device cover, or a user input indicating a type or model of screen protector or case disposed over a device cover).

In some embodiments, a determined thickness of a cover stack can be used to appropriately interpret image data obtained from the image sensor 400 (e.g., to determine what kind of target feature magnification ratio should be expected, and thereby interpret how fast a target is moving) and/or adapt the image sensor 400. Adaptations of the image sensor 400 may include, for example, an adaptation to read out image data from a particular ROI, or read out image data in a binned pixel mode or a non-binned pixel mode, depending on a determined cover stack thickness and expected target feature magnification ratio.

In some embodiments, the image sensor 400 may be operated in a binned pixel mode or a non-binned pixel mode, depending on a determined thickness of a cover stack. For example, the image sensor 400 may be a quadra-pixel image sensor, in which a non-binned pixel value may be read out for each pixel 402, or a binned pixel value may be read out for subsets of four “binned”pixels 402 (i.e., the ratio of non-binned pixels 402 to binned pixels 414 may be 4:1).

When a thickness of a cover stack is within a first range of thickness, the image sensor 400 may be operated in the binned pixel mode, and when the thickness of the cover stack is within a second range of thicknesses (that is non-overlapping with the first range of thicknesses), the image sensor 400 may be operated in the non-binned pixel mode.

In some embodiments, the operation of the image sensor 400 may be toggled between the binned pixel mode and the non-binned pixel mode, responsive to the thickness of the cover stack. However, an image sensor could also be switched between a non-binned pixel mode and multiple different binned pixel modes.

To simplify image processing, different portions of the image sensor 400 may be read out, depending on the thickness of a cover stack and depending on whether the image sensor 400 is being operated in a binned pixel mode or a non-binned pixel mode. For example, when the thickness of the cover stack is within a first range of thicknesses (e.g., a range of smaller thicknesses), the pixels 402 of a 32×32 pixel array may be binned and read out as a 16×16 array of binned pixel values. When the thickness of the cover stack is within a second range of thicknesses (e.g., a range of greater thicknesses), a set of non-binned pixel values may be read out of a subset (or portion 410) of the pixels 402. For example, non-binned pixel values may be read out of a 16×16 array of pixels 402. In this manner, the number of non-binned pixels or binned pixel values read out from the 2D array of pixels 402 is the same, and similar image processing techniques may be applied to each set of pixel values (with, for example, appropriate different interpretations of magnification ratio). As shown in FIGS. 4A and 4B, the portion 410 of the pixels 402 may be a portion that is not affected (or minimally affected) by flare 404 or 408.

In some embodiments, the portion 410 of the pixels 402 may be predetermined, and the image sensor 400 may be toggled between a binned pixel mode in which binned pixel values are read out from all of the pixels 402 of the image sensor 400, and a non-binned pixel mode in which non-binned pixel values are read out from a predetermined portion 410 of the pixels 402. In other embodiments, the portion 410 of the pixels 402 that is read out during the non-binned pixel mode may be determined dynamically, depending on the thickness of a cover stack and/or the presence of flare (e.g., flare 404 or 408).

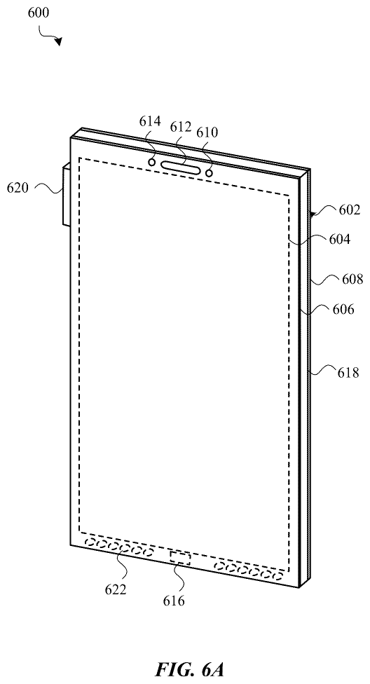

FIG. 5 shows an example method 500 that may be performed by a processor of an optical sensor, such as the optical flow sensor described with reference to FIGS. 3A and 3B.

At 502, the method 500 may include acquiring an image from a 2D array of pixels of an image sensor of the optical flow sensor.

At 504, the method 500 may include analyzing the image to determine at least one of whether flare is in the image, a presence or position of flare in the image, or a position of a target or target feature in the image. Additionally or alternatively, the method 500 may include receiving a cover stack thickness as user input or system input, or receiving one or more identifiers of one or more cover layer types or cover layer models, from which a cover stack thickness can be determined and used in the analysis at 504. In some embodiments, the user input or system input may be used in the analysis in lieu of the image acquired at 502.

At 506, the method 500 may include adapting the image sensor based at least in part on the analysis at 504.

The method 500 may be variously embodied, extended, or adapted, as described in the following paragraphs and elsewhere in this description.

In some embodiments, the method 500 may include acquiring the image from the 2D array of pixels (at 502) while operating at least a first portion of the 2D array of pixels in a binned pixel mode. The image sensor may then be adapted (at 506), at least in part, by configuring at least a second portion of the image sensor, based at least in part on the analysis, to operate in one of the binned pixel mode or a non-binned pixel mode (e.g., based on the absence, presence, or position of flare, or the position of a target or target feature in the image). In these embodiments, the method 500 may further include sensing the movement of the object on the second side of the cover stack using the configured at least second portion of the image sensor.

In some embodiments of the method 500, the image sensor may be adapted (at 506), at least in part, by selecting an image sensor read-out ROI. For example, the read-out ROI may be adapted (changed) based on the absence, presence, or position of flare, or the position of a target or target feature in the image. In some of these embodiments, the method 500 may include acquiring the image from the 2D array of pixels (at 502) while operating at least a portion of the 2D array of pixels in a binned pixel mode. In some embodiments, the portion of the image sensor may be the entire image sensor. In some embodiments, the method 500 may include periodically acquiring an image using the entire image sensor, regardless of whether the current read-out ROI includes a smaller portion of the image sensor, to assess whether the absence, presence, or position of flare, or the position of a target or target feature in the image has changed. The read-out ROI may then be adapted if the absence, presence, or position of flare, or the position of a target or target feature in the image, has changed.

In some embodiments of the method 500, the image sensor may be adapted (at 506), at least in part, by configuring a displacement gain factor. For example, because of a change in target feature magnification ration due to a change in cover stack thickness, the displacement gain factor applied to displacement measurements obtained from one or more images may be changed. In some of these embodiments, the method 500 may include sensing the movement of the object on the second side of the cover stack based at least in part on a frame-by-frame analysis of the image in accordance with the displacement gain factor.

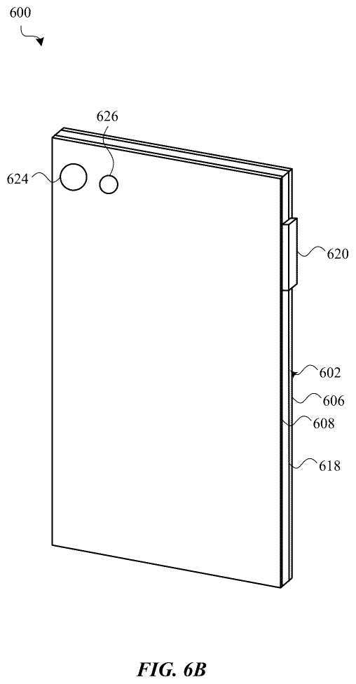

FIGS. 6A and 6B show an example of a device 600 that may include an optical flow sensor (or other type of optical sensor, thereby making the device 600 an opto-electronic device, although the device 600 may also have other purposes and functions). The device's dimensions and form factor, including the ratio of the length of its long sides to the length of its short sides, suggest that the device 600 is a mobile phone (e.g., a smartphone). However, the device's dimensions and form factor are arbitrarily chosen, and the device 600 could alternatively be any portable electronic device including, for example a tablet computer, portable computer, portable music player, wearable device (e.g., an electronic watch, health monitoring device, fitness tracking device, headset, or glasses), augmented reality (AR) device, virtual reality (VR) device, mixed reality (MR) device, gaming device, portable terminal, digital single-lens reflex (DSLR) camera, video camera, vehicle navigation system, robot navigation system, or other portable or mobile device. The device 600 could also be a device that is semi-permanently located (or installed) at a single location. FIG. 6A shows a front isometric view of the device 600, and FIG. 6B shows a rear isometric view of the device 600. The device 600 may include a housing 602 that at least partially surrounds a display 604. The housing 602 may include or support a front cover 606 or a rear cover 608. The front cover 606 may be positioned over the display 604 and may provide a window through which the display 604 may be viewed. In some embodiments, the display 604 may be attached to (or abut) the housing 602 and/or the front cover 606. In alternative embodiments of the device 600, the display 604 may not be included and/or the housing 602 may have an alternative configuration.

The display 604 may include one or more light-emitting elements, and in some cases may be a light-emitting diode (LED) display, an organic LED (OLED) display, a liquid crystal display (LCD), an electroluminescent (EL) display, or another type of display. In some embodiments, the display 604 may include, or be associated with, one or more touch and/or force sensors that are configured to detect a touch and/or a force applied to a surface of the front cover 606.

The various components of the housing 602 may be formed from the same or different materials. For example, a sidewall 618 of the housing 602 may be formed using one or more metals (e.g., stainless steel), polymers (e.g., plastics), ceramics, or composites (e.g., carbon fiber). In some cases, the sidewall 618 may be a multi-segment sidewall including a set of antennas. The antennas may form structural components of the sidewall 618. The antennas may be structurally coupled (to one another or to other components) and electrically isolated (from each other or from other components) by one or more non-conductive segments of the sidewall 618. The front cover 606 may be formed, for example, using one or more of glass, a crystal (e.g., sapphire), or a transparent polymer (e.g., plastic) that enables a user to view the display 604 through the front cover 606. In some cases, a portion of the front cover 606 (e.g., a perimeter portion of the front cover 606) may be coated with an opaque ink to obscure components included within the housing 602. The rear cover 608 may be formed using the same material(s) that are used to form the sidewall 618 or the front cover 606. In some cases, the rear cover 608 may be part of a monolithic element that also forms the sidewall 618 (or in cases where the sidewall 618 is a multi-segment sidewall, those portions of the sidewall 618 that are conductive or non-conductive). In still other embodiments, all of the exterior components of the housing 602 may be formed from a transparent material, and components within the device 600 may or may not be obscured by an opaque ink or opaque structure within the housing 602.

The front cover 606 may be mounted to the sidewall 618 to cover an opening defined by the sidewall 618 (i.e., an opening into an interior volume in which various electronic components of the device 600, including the display 604, may be positioned). The front cover 606 may be mounted to the sidewall 618 using fasteners, adhesives, seals, gaskets, or other components.

A display stack or device stack (hereafter referred to as a “stack”) including the display 604 may be attached (or abutted) to an interior surface of the front cover 606 and extend into the interior volume of the device 600. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 606 (e.g., to a display surface of the device 600).

In some cases, a force sensor (or part of a force sensor system) may be positioned within the interior volume above, below, and/or to the side of the display 604 (and in some cases within the device stack). The force sensor (or force sensor system) may be triggered in response to the touch sensor detecting one or more touches on the front cover 606 (or a location or locations of one or more touches on the front cover 606) and may determine an amount of force associated with each touch, or an amount of force associated with a collection of touches as a whole. In some embodiments, the force sensor (or force sensor system) may be used to determine a location of a touch, or a location of a touch in combination with an amount of force of the touch. In these latter embodiments, the device 600 may not include a separate touch sensor.

As shown primarily in FIG. 6A, the device 600 may include various other components. For example, the front of the device 600 may include one or more front-facing cameras 610 (including one or more 3D image sensors or depth sensors), speakers 612, microphones, or other components 614 (e.g., audio, imaging, and/or sensing components (e.g., a proximity sensor, such as one of the proximity sensors described herein)) that are configured to transmit or receive signals to/from the device 600. In some cases, a front-facing camera 610, alone or in combination with other sensors, may be configured to operate as a bio-authentication or facial recognition sensor. In some embodiments, a flash or electromagnetic radiation source (e.g., a visible or IR light source) may be positioned near the front-facing camera. In some cases, the front-facing camera 610 may be positioned behind the display 604 and receive electromagnetic radiation (e.g., light) through the display 604. In some cases, a proximity sensor or depth sensor may be used to determine a distance to a user or generate a depth map of the user's face, or determine a distance or proximity to an object or generate a depth map of the object (or of objects in a FoV that includes the object). The device 600 may also include various input devices, such as one or more optical sensors 616. By way of example, optical sensor 616 is shown to be positioned adjacent a lower edge of the display 604. The optical sensor 616 may sense through the front cover 606, and may be used to track movement of a user's thumb or another finger (with the term “finger” broadly including any of a user's digits). Tracked movement of the user's thumb may be used, for example, to unlock the device 600, to position an icon on a graphical user interface of the display 604, to switch between screens of the graphical user interface, et cetera. Alternatively or additionally, an optical sensor may be provided in the button 620, to detect movement on the button 620; anywhere within the housing 602 to detect movement on a surface of the housing; et cetera.

The device 600 may also include buttons or other input devices positioned along the sidewall 618 and/or on a rear surface of the device 600. For example, a volume button or multipurpose button 620 may be positioned along the sidewall 618, and in some cases may extend through an aperture in the sidewall 618. The sidewall 618 may include one or more ports 622 that allow air, but not liquids, to flow into and out of the device 600. In some embodiments, one or more sensors may be positioned in or near the port(s) 622. For example, an ambient pressure sensor, ambient temperature sensor, internal/external differential pressure sensor, gas sensor, particulate matter concentration sensor, or air quality sensor may be positioned in or near a port 622.

In some embodiments, the rear surface of the device 600 may include a rear-facing camera 624 that includes one or more 3D image sensors or depth sensors (see FIG. 6B). A flash or electromagnetic radiation source 626 (e.g., a visible or IR light source) may also be positioned on the rear of the device 600 (e.g., near the rear-facing camera). In some cases, the rear surface of the device 600 may include multiple rear-facing cameras.

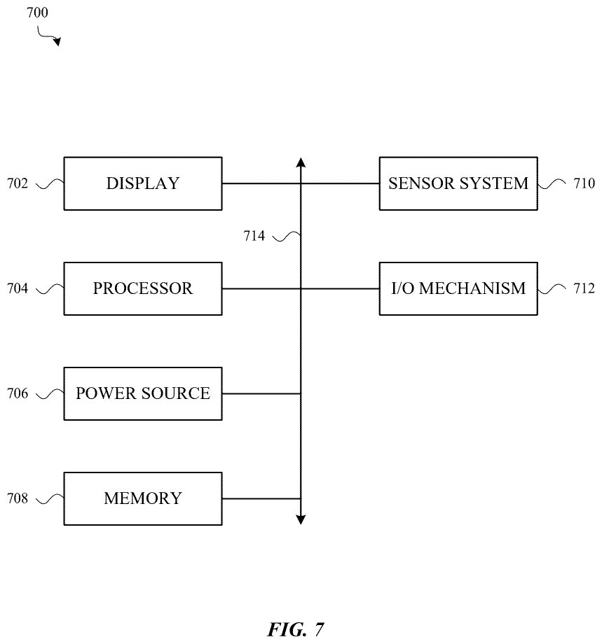

FIG. 7 shows a sample electrical block diagram of an electronic device 700 that includes an optical sensor, such as an optical flow sensor constructed or configured in accordance with the principles described with reference to any of FIGS. 1A-6 or elsewhere in this description. The electronic device 700 may take forms such as a hand-held or portable device (e.g., a smartphone, tablet computer, or electronic watch), a wearable device, a computing device, a navigation system of a vehicle, and so on. The electronic device 700 may include an optional display 702 (e.g., a light-emitting display), a processor 704, a power source 706, a memory 708 or storage device, a sensor system 710, and an optional input/output (I/O) mechanism 712 (e.g., an input/output device and/or input/output port). The processor 704 may control some or all of the operations of the electronic device 700. The processor 704 may communicate, either directly or indirectly, with substantially all of the components of the electronic device 700. For example, a system bus or other communication mechanism 714 may provide communication between the processor 704, the power source 706, the memory 708, the sensor system 710, and/or the input/output mechanism 712.

The processor 704 may be implemented as any electronic device capable of processing, receiving, or transmitting data or instructions. For example, the processor 704 may be a microprocessor, a central processing unit (CPU), an ASIC, a DSP, a controller, or any combination of such devices. As described herein, the term “processor” is meant to encompass a single processor or processing unit, multiple processors, multiple processing units, or another suitably configured computing element or elements.

In some embodiments, the components of the electronic device 700 may be controlled by multiple processors. For example, select components of the electronic device 700 may be controlled by a first processor and other components of the electronic device 700 may be controlled by a second processor, where the first and second processors may or may not be in communication with each other.

The power source 706 may be implemented with any device capable of providing energy to the electronic device 700. For example, the power source 706 may include one or more disposable or rechargeable batteries. Additionally or alternatively, the power source 706 may include a power connector or power cord that connects the electronic device 700 to another power source, such as a wall outlet.

The memory 708 may store electronic data that may be used by the electronic device 700. For example, the memory 708 may store electrical data or content such as, for example, audio and video files, documents and applications, device settings and user preferences, timing signals, control signals, data structures or databases, image data, maps, or focus settings. The memory 708 may be configured as any type of memory. By way of example only, the memory 708 may be implemented as random access memory, read-only memory, Flash memory, removable memory, other types of storage elements, or combinations of such devices.

The electronic device 700 may also include one or more sensors defining the sensor system 710. The sensors may be positioned substantially anywhere on the electronic device 700. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 710 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, a proximity sensor, and so on. Additionally, the one or more sensors may utilize any suitable sensing technology, including, but not limited to, capacitive, ultrasonic, resistive, optical, ultrasound, piezoelectric, and thermal sensing technologies.

The I/O mechanism 712 may transmit and/or receive data from a user or another electronic device. An I/O device may include a display, a touch sensing input surface such as a track pad, one or more buttons (e.g., a graphical user interface “home” button, or one of the buttons described herein), one or more cameras (including one or more 2D or 3D image sensors (e.g., one or more SPAD-based photon detectors)), one or more microphones or speakers, one or more ports such as a microphone port, and/or a keyboard. Additionally or alternatively, an I/O device or port may transmit electronic signals via a communications network, such as a wireless and/or wired network connection. Examples of wireless and wired network connections include, but are not limited to, cellular, Wi-Fi, Bluetooth, IR, and Ethernet connections. The I/O mechanism 712 may also provide feedback (e.g., a haptic output) to a user.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

As described above, one aspect of the present technology may be the gathering and use of data available from various sources (e.g., user movements). The present disclosure contemplates that, in some instances, this gathered data may include personal information data (e.g., biological information (e.g., fingerprints), positional information, location information, or contextual information) that uniquely identifies or can be used to identify, locate, contact, or diagnose a specific person. Such personal information data can include demographic data, location-based data, telephone numbers, email addresses, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to activate or deactivate various functions of the user's device, or gather performance metrics for the user's device or the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States (US), collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users may selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, et cetera), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. An opto-electronic device, comprising:
an optical sensor, including,
an image sensor having a two-dimensional (2D) array of pixels; and
a light source operable to illuminate at least a portion of a field of view imaged by the image sensor;
a cover stack that passes light emitted by the light source and light received by the image sensor; and
a processor configured to,
determine a thickness of the cover stack; and
operate at least a portion of the 2D array of pixels in one of a binned pixel mode or a non-binned pixel mode, responsive to the determined thickness of the cover stack.

2. The opto-electronic device of claim 1, wherein:
the processor is configured to,
operate at least a first portion of the 2D array of pixels in the binned pixel mode when the determined thickness of the cover stack is within a first range of thicknesses; and
operate at least a second portion of the 2D array of pixels in the non-binned pixel mode when the determined thickness of the cover stack is within a second range of thicknesses that is non-overlapping with the first range of thicknesses.

3. The opto-electronic device of claim 2, wherein the at least the first portion of the 2D array of pixels comprises more pixels than the at least the second portion of the 2D array of pixels.

4. The opto-electronic device of claim 1, wherein a ratio of non-binned pixels to binned pixels is 4:1.

5. The opto-electronic device of claim 4, wherein a first number of binned pixel values obtained from the 2D array of pixels in the binned pixel mode is equal to a second number of non-binned pixel values obtained from the 2D array of pixels in the non-binned pixel mode.

6. The opto-electronic device of claim 1, wherein:
the processor is configured to,
acquire at least one image from the image sensor;
analyze a pattern of light in the at least one image; and
determine the thickness of the cover stack based at least in part on the analysis of the pattern of light.

7. The opto-electronic device of claim 6, wherein analyzing the pattern of light comprises determining a presence or position of flare in the at least one image.

8. The opto-electronic device of claim 6, wherein analyzing the pattern of light comprises determining a position of a target or a target feature within the at least one image.

9. The opto-electronic device of claim 1, wherein the processor is configured to determine the thickness of the cover stack based at least in part on a received thickness or an identifier of a layer of the cover stack.

10. The opto-electronic device of claim 1, wherein the light source has a fixed position with respect to the image sensor.

11. The opto-electronic device of claim 1, wherein the image sensor comprises a complimentary metal-oxide semiconductor (CMOS) image sensor.

12. An opto-electronic device, comprising:
a cover stack; and
an optical sensor positioned on a first side of the cover stack and configured to sense movement of a target on a second side of the cover stack, the second side opposite the first side, the optical sensor including,
an image sensor having a two-dimensional (2D) array of pixels;
a light source operable to illuminate at least a portion of a field of view imaged by the image sensor; and
a depth of field (DoF) extension lens disposed between the image sensor and the cover stack, in a light reception path of the image sensor.

13. The opto-electronic device of claim 12, further comprising a beam-shaping lens disposed between the light source and the cover stack, in a light emission path of the light source.

14. The opto-electronic device of claim 12, wherein:
the cover stack includes a cover of the opto-electronic device; and
a mirror image of the light source is outside the field of view imaged by the image sensor for at least a range of thicknesses of the cover stack up to two times a thickness of the cover.

15. An opto-electronic device, comprising:
a cover stack;
an optical sensor positioned on a first side of the cover stack and configured to sense movement of a target on a second side of the cover stack, the second side opposite the first side, the optical sensor including an image sensor having a two-dimensional (2D) array of pixels; and
a processor configured to,
acquire an image from the 2D array of pixels;
analyze the image to determine at least one of,
whether flare is in the image;
a presence or position of flare in the image; or
a position of the target or a target feature in the image; and
adapt the image sensor based at least in part on the analysis.

16. The opto-electronic device of claim 15, wherein:
the processor is configured to,
acquire the image from the 2D array of pixels while operating at least a first portion of the 2D array of pixels in a binned pixel mode;
adapt the image sensor, at least in part, by configuring at least a second portion of the image sensor, based at least in part on the analysis, to operate in one of the binned pixel mode or a non-binned pixel mode; and
sense the movement of the target on the second side of the cover stack using the configured at least second portion of the image sensor.

17. The opto-electronic device of claim 15, wherein:
the processor is configured to,
adapt the image sensor, at least in part, by selecting an image sensor read-out region of interest (ROI).

18. The opto-electronic device of claim 17, wherein:
the processor is configured to,
acquire the image from the 2D array of pixels while operating at least a portion of the 2D array of pixels in a binned pixel mode.

19. The opto-electronic device of claim 15, wherein:
the processor is configured to,
adapt the image sensor, at least in part, by configuring a displacement gain factor; and
sense the movement of the target on the second side of the cover stack based at least in part on a frame-by-frame analysis of the image in accordance with the displacement gain factor.

20. The opto-electronic device of claim 15, further comprising receive optics disposed between the image sensor and the cover stack, in a light reception path of the image sensor, the receive optics directing light received at different angles of incidence on the Rx optics to different portions of the image sensor.
